(19) United States
(12) Patent Application Publication
(10) Pub. No.: US 2026/0235994 A1
(43) Pub. Date: Aug. 13, 2026

(54) METHOD AND MACHINE CONTROLLER FOR CONTROLLING A MACHINE

(71) Applicant: Siemens Aktiengesellschaft, München (DE)

(72) Inventors: Philipp Wissmann, München (DE); Daniel Hein, München (DE); Steffen Udluft, München (DE)

(21) Appl. No.: 19/532,124

(22) Filed: Feb. 6, 2026

(30) Foreign Application Priority Data
Feb. 10, 2025 (EP) 25156855.6

(51) Int. Cl. G05B 13/02

(52) U.S. Cl. CPC G05B 13/027

(57) ABSTRACT

Operating states and control actions specified in first training data sets are taken as a basis for assigning a respective operating state of the machine multiple control actions. This trains a machine learning module to take an operating state and a control action as a basis for predicting a performance of the machine that is accumulated over a state trajectory, which is constructed by determining a particular control action to be applied on the basis of output values of the machine learning module. A performance evaluator is used to determine a performance value. An accumulated performance for each of the alternative control actions associated with a respective current operating state of the machine is predicted. The machine is then actuated using a control action. If the optimizing control action is not executed successfully, another of the alternative control actions is selected.

### CROSS REFERENCE TO RELATED APPLICATIONS

This application claims priority to EP Application No. 25156855.6, having a filing date of February 10, 2025, the entire contents of which are hereby incorporated by reference.

### FIELD OF TECHNOLOGY

The following relates to a method and machine controller for controlling a machine.

### BACKGROUND

Data-driven machine learning methods are increasingly being used in the control of complex machines, for example robots, motors, production plants, machine tools, milling machines, gas turbines, wind turbines, cooling plants, heating plants or internal combustion engines.

Such learning methods can be used to train a machine controller to generate, for a respective operating state of the machine, a state-specific control action for controlling the machine that specifically brings about a desired or optimized behavior of the machine and thus optimizes the performance thereof. A method that is used to select a control action to be applied in the current state is often also referred to as a policy or action selection rule.

A plurality of known training methods are available for training such a learning-based machine controller, such as reinforcement learning methods.

Successful training generally requires large volumes of operating data relating to the machine to be controlled or a similar machine as training data. In this case, the training data should cover the possible operating states and other operating conditions of the machine as representatively as possible. In many cases, such training data are available in the form of databases in which operating data recorded on the machine are stored. Such stored training data are often also referred to as batch training data or offline training data.

While a machine is in operation, the problem often arises that the operating conditions thereof change unexpectedly and/or that a change is not detected, not detected in time or detected incompletely. In embodiments, it may not become apparent that a control action cannot currently be executed or executed successfully until there is an attempt to apply the control action. For example, in many cases a valve blockage is not detected until a control action to close or open the valve is supposed to be executed.

In such cases, a suitable alternative control action should be executed as seamlessly as possible, especially for safety-critical or process-critical applications.

### SUMMARY

An aspect relates to a method and a machine controller for controlling a machine that are more robust in the face of unforeseen events during the operating sequence.

According to embodiments of the invention, to control a machine, a plurality of first training data sets are read in, in each of which an operating state of the machine has an associated control action. The operating states and control actions specified in the first training data sets are used to generate further training data sets with new associations between operating states and control actions, so that a respective operating state is assigned multiple alternative control actions. Furthermore, a machine learning module is trained by the first and further training data sets to take an operating state and a control action as a basis for predicting a machine performance accumulated over a state trajectory of consecutive operating states as a resulting output value. In the course of this, an operating state subsequent to a particular considered operating state in a state trajectory is determined by feeding, for each of the alternative control actions associated with the considered operating state, the considered operating state and the respective alternative control action into the machine learning module, taking the resulting output values of the machine learning module as a basis for selecting one of the alternative control actions, and using a simulator of the machine to determine an operating state that results from application of the selected control action to the considered operating state as the subsequent operating state. Furthermore, a performance evaluator is used to determine a performance value accumulated over the operating states in a respective state trajectory, and the machine learning module is trained to reproduce the determined

accumulated performance values. To control the machine, a current operating state of the machine is detected and an accumulated performance for each of the alternative control actions associated with the current operating state is predicted by the trained machine learning module. The machine is then actuated using a control action that optimizes the predicted accumulated performance, and if the optimizing control action is not executed successfully, another of the alternative control actions is selected on the basis of the accumulated performance thereof to control the machine.

To carry out the method according to embodiments of the invention, there is provision for a machine controller, a computer program product (non-transitory computer readable storage medium having instructions, which when executed by a processor, perform actions) and a, non-volatile, computer-readable storage medium.

The method according to embodiments of the invention and the machine controller according to the invention may be carried out and implemented, respectively, for example by one or more computers, processors, application-specific integrated circuits (ASICs), digital signal processors (DSPs) and/or what are known as field-programmable gate arrays (FPGAs). The method according to embodiments of the invention can furthermore be carried out at least in part in a cloud and/or in an edge computing environment.

An advantage of embodiments of the invention can be seen in particular in that if a control action is not executed successfully, one or more alternative control actions already evaluated in terms of their accumulated performance can be applied directly. For example, if the control action with the best accumulated performance cannot currently be applied, the alternative control action with the second best accumulated performance can be applied directly.

In addition, in many cases it turns out that the respective accumulated performance is also predicted by the trained machine learning module relatively accurately for state trajectories that are induced by the artificially generated new associations between operating states and control actions.

According to one embodiment of the invention, alternative control actions associated with the current operating state can be output together with a particular predicted accumulated performance via a user interface to select a control action to be executed. This allows an informed decision or intervention by an operator, in particular if there are unforeseen events during the operating sequence. By comparing the accumulated performance values of the alternative control actions, the operator can in many cases make an informed decision as to whether a given control action can be replaced by an alternative control action without any significant performance losses, or they can at least weigh up whether or not such a replacement is acceptable.

According to an embodiment of the invention, a respective operating state specified in the first training data sets can have, in addition to an associated control action, an associated next state that results from application of the control action to the operating state. In many cases, such data on next states can easily be acquired concurrently with the detection of operating states and control actions.

The simulator can thus be trained by the first training data setsbefore the machine learning module is trained, to take a respective operating state and a respective control action as a basis for reproducing the particular resulting next state. In this way, the first training data sets can also be used to implement the simulator. The first training data sets used to train the simulator do not generally contain the new associations of alternative control actions. However, in many cases it turns out that simulators trained in this manner have good abstraction capability and can predict next states relatively correctly even for new control actions. In addition, any prediction inaccuracies of the simulator can often be compensated for at least in part by training the machine learning module.

The operating states, control actions and/or next states specified in the first training data sets can be detected while the machine or a machine of the same design or a similar machine is in operation. In this way, realistic training data tailored specifically to the machine to be controlled can be obtained. The training data can be obtained in particular by a sensor system of the machine or the similar machine. For this purpose, the sensor system can continuously measure or determine state variables, state parameters, control parameters or other operating parameters of the machine in question and store or otherwise provide them in the form of training data sets.

According to an embodiment of the invention, control actions that can be applied in a respective operating state can be determined. The respective operating state can then be assigned all control actions that can be applied as alternative control actions. In this way, generating the further training data sets allows a space of potential control options to be covered better. State trajectories that are not covered by the first training data sets can thus also be taken into account when predicting the performance or controlling the machine.

Alternatively or additionally, multiple control actions can be selected for a respective operating state according to a predefined criterion from all control actions specified in the first training data sets and can be assigned to the respective operating state as alternative control actions. The criterion used can be in particular an executability, an admissibility, an application risk, a reliability, a similarity to other control actions and/or a frequency of application of the control action to be selected.

According to an embodiment of the invention, the determination of a subsequent operating state in the state trajectory can result in the alternative control action that optimizes, in particular maximizes, the resulting output value of the machine learning module being selected. Insofar as the training of the machine learning module is focussed on the output value thereof reproducing the accumulated performance, it can be expected that an alternative control action that optimizes the output value correlates more and more often in the course of the training with a control action that optimizes the accumulated performance. Accordingly, in many cases the state trajectories determined in the course of the training of the machine learning module reflect the state trajectories undergone during performance-optimized operation of the machine sufficiently realistically.

According to an embodiment of the invention, if a first control action is not executed successfully, the other alternative control action for which the next best accumulated performance compared to the first control action was predicted can be selected to control the machine. In this way, a different control action already evaluated in terms of its accumulated performance can already be executed directly after a disturbance in execution has been detected. In addition, resulting performance losses can be evaluated, taken into account and/or communicated directly. Optionally, before the other alternative control action is executed, it is possible to check whether a distance between the best and next best accumulated performances exceeds a predefined threshold value. If the threshold value is exceeded, execution of the other alternative control action can be stopped at least temporarily and/or a consultation with an operator can be initiated.

According to an embodiment of the invention, an action selection rule for selecting a control action to be applied in a current operating state can be implemented in such a way that an accumulated performance is predicted by the trained machine learning module for the current operating state and each of one or more control actions that can be applied, and that the control action of the one or more control actions that can be applied for which the best accumulated performance was predicted is then selected as the control action to be applied. The trained machine learning module can thus easily be used to implement an efficient performance-optimizing policy. The control action to be applied can be selected for example by a so-called arg max function (arg max: argument of the maximum).

Furthermore, a control quality can be derived from the accumulated performance values during the training of the machine learning module. The training can then be continued until a predefined control quality is attained. The control quality derived can be in particular a statistical mean value of the accumulated performance values, for example a moving average over time.

### BRIEF DESCRIPTION

Some of the embodiments will be described in detail, with reference to the following figures, wherein like designations denote like members, wherein

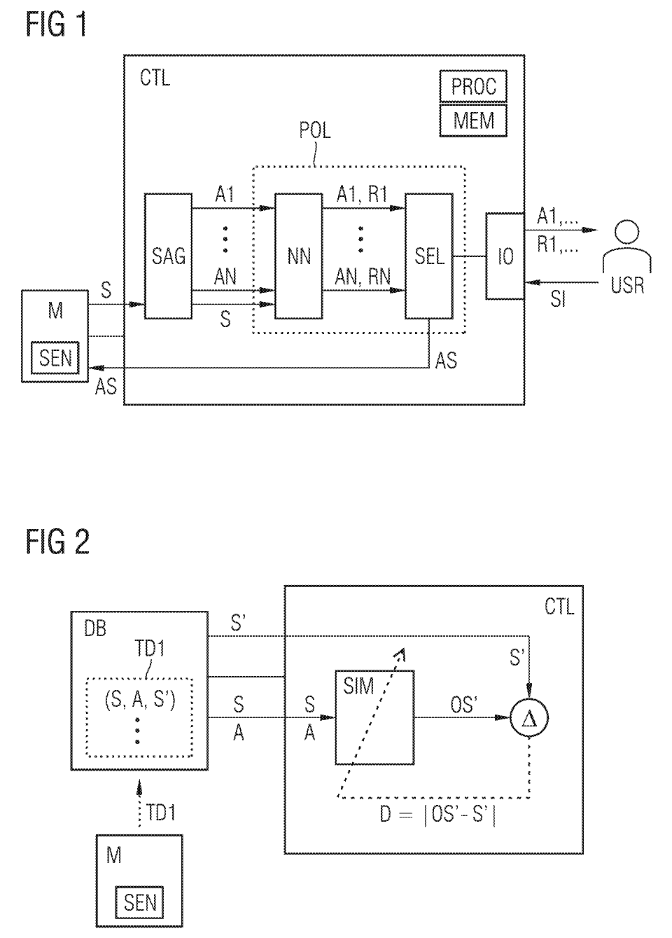

FIG. 1 shows a learning-based machine controller when controlling a machine;

FIG. 2 shows training of a learning-based simulator of the machine; and

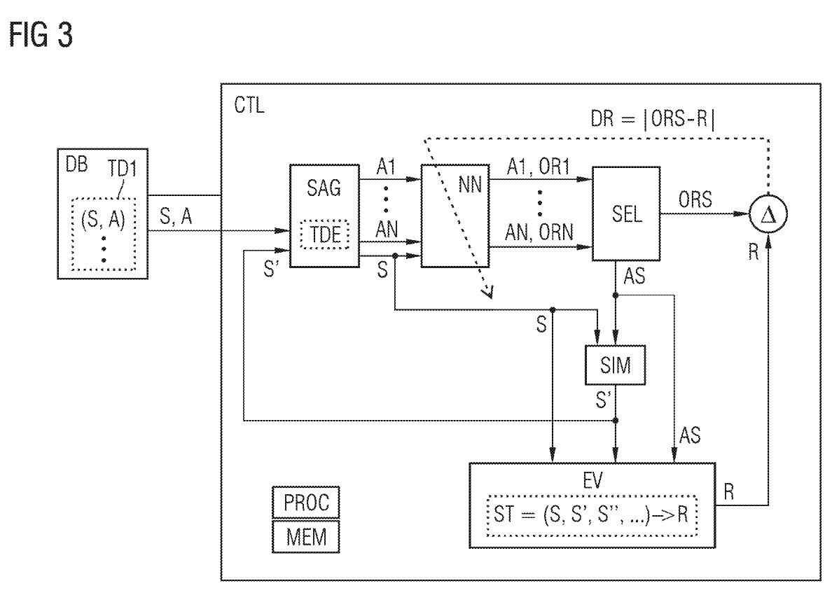

FIG. 3 shows training of a machine learning module for predicting an accumulated performance of state trajectories.

### DETAILED DESCRIPTION

FIG. 1 illustrates an example of a learning-based machine controller CTL when controlling a machine M, which in the present exemplary embodiment is in the form of a robot, e.g. a production robot. Alternatively or additionally, the machine M may also be a motor, a production plant, a factory, a machine tool, a milling machine, a gas turbine, a wind turbine, a steam turbine, a chemical reactor, an internal combustion engine, a cooling plant or a heating plant.

The machine M is coupled with the machine controller CTL, which may be implemented as part of the machine M or wholly or in part externally to the machine M. FIG. 1 shows the machine controller CTL externally to the machine M for reasons of clarity. The machine controller CTL comprises one or more processors PROC for executing the claimed method steps of the machine controller CTL and one or more memories MEM that are coupled with the processor PROC and intended to store the data to be processed by the machine controller CTL.

The machine M has a sensor system SEN that continuously measures various current operating parameters of the machine M while the machine is in operation, and outputs them as state values. The state values can be used in particular to quantify physical, control-related, chemical and/or effect-related state variables, sensor data, environmental data or other operating parameters that arise or influence operation during operation of the machine M. The state variables in this case can include a temperature, a pressure, a setting, an actuator position, a valve position, a pollutant emission, a utilization level, a resource consumption and/or a power of the machine M or a component thereof. In the case of a production plant or a machine tool, the state values can also include a product quality, a processing quality, or another product property. In the case of a turbine, the state values can include a turbine power, a rotation speed, vibration frequencies, vibration amplitudes, combustion dynamics, change of combustion pressure amplitudes or nitrogen oxide concentrations.

The state values currently measured by the sensor system SEN and, where applicable, otherwise determined state values of the machine M are combined to form a current state data set S that quantifies a current operating state of the machine M.

The continuous determination of current state values generates a chronological succession of current state data sets S while the machine M is in operation, which is continuously transmitted from the machine M to the machine controller CTL.

The machine controller CTL uses the state data sets S, which quantify a respective current operating state of the machine M, to derive control actions AS that are currently to be applied to control the machine M. The control actions AS to be applied can then be transmitted to the machine M, for example each in the form of a control signal.

The control actions AS to be applied are determined by a machine learning module NN of the machine controller CTL.

The machine learning module NN is trained in advance to take an operating state and a control action as a basis for predicting a thus induced performance of the machine M accumulated over multiple time steps into the future. In the context of machine learning, such a performance accumulated over multiple time steps into the future is often also referred to as a return. A sequence of this training is explained in more detail below.

The performance in this case can include in particular a power, a yield, a speed, a running time, a precision, an error rate, a resource consumption, an effectiveness, an efficiency, a pollutant emission, a stability, wear, a service life, a physical property, a mechanical property, an electrical property, a secondary condition to be complied with or other target variables to be optimized for the machine M or one of its components.

To determine the control action AS to be applied in an operating state specified by a current state data set S, the current state data set S is fed into a control action generator SAG of the machine controller CTL.

The control action generator SAG serves, among other things, the purpose of determining for a respective operating state those control actions that can potentially be applied in this operating state. Which control actions can be applied can be determined according to a predefined criterion.

The criterion used can be in particular an executability, an admissibility, an application risk, a reliability, a similarity to other control actions and/or a frequency of application of the control action in question. The control actions that can potentially be applied can in particular be taken from a database that stores operating states and control actions of the machine M or a machine of the same design that are detected while the machine is in operation.

For the present exemplary embodiment, it will be assumed that control actions A1, A2, …, AN can potentially be applied in the operating state of the machine M that is specified by the state data set S. The control actions are referred to as alternative control actions insofar as they can be applied as alternatives to one another. Accordingly, the control action generator SAG takes the state data set S as a basis for generating the alternative control actions A1, …, AN, each of which is fed into the trained machine learning module NN as input data in association with the state data set S.

On the basis of the state data set S and a respective alternative control action A1, …, or AN, the trained machine learning module NN predicts a respective performance R1, …, or RN of the machine M accumulated over multiple time steps into the future as output data. The respective alternative control action A1, …, or AN is assigned to the particular thus induced accumulated performance R1, …, or RN.

Each of the alternative control actions A1, …, AN is transmitted together with the particular associated accumulated performance R1, …, or RN to a selection module SEL of the machine controller CTL.

The selection module SEL first selects the alternative control action of the alternative control actions A1, …, AN that has the highest or best associated accumulated performance R1, … or RN as the control action AS to be applied. This performance-optimizing control action AS is output by the selection module SEL and transmitted from the machine controller CTL to the machine M, for example in the form of a control signal, in order to control the machine.

Successful execution of a control action AS to be applied is monitored by the machine controller CTL by the sensor system SEN. If it is detected that the control action AS to be applied cannot currently be executed successfully or has not been executed successfully, the selection module SEL selects another of the alternative control actions A1, …, AN to control the machine M. In an embodiment, this results in the other alternative control action for which the next best accumulated performance R1, R2, … or RN compared to the previously applied control action AS was predicted being selected. The control action selected in this way is then transmitted to the machine M as the control action to be applied, in order to control the machine. In this way, a different control action already evaluated in terms of its accumulated performance can already be applied directly after a disturbance in execution has been detected.

The machine M is controlled by virtue of the particular control action transmitted to the machine M being executed by the machine M. In this way, e.g. a robot can be induced by appropriate control actions to follow an optimized motion trajectory. Similarly, in the case of a gas turbine, a gas supply, a gas distribution and/or an air supply can be adjusted using appropriate control actions.

Optionally, before the selected other alternative control action is executed, the machine controller CTL can check whether a distance between the accumulated performance of the previously applied control action AS and the next best accumulated performance exceeds a predefined threshold value. If the threshold value is exceeded, execution of the selected other alternative control action can be stopped at least temporarily and/or a consultation with an operator USR can be initiated.

Alternatively or additionally, the alternative control actions A1, …, AN associated with the current operating state, or a selection of the alternative control actions, can be output by the selection module SEL, together with the particular associated accumulated performance R1, …, or RN, to the operator USR via a user interface IO to select a control action to be executed. This allows an informed decision or intervention by the operator USR, in particular if there are unforeseen events during the operating sequence. By comparing the accumulated performance of the alternative control actions, the operator can in many cases make an informed decision as to whether a given control action can be replaced by an alternative control action without any significant performance losses, or they can at least weigh up whether or not such a replacement is acceptable.

Selection information SI, which is then entered by the operator USR, that identifies the control action to be executed can then be read in by the selection module SEL via the user interface IO. On the basis of the selection information SI that has been read in, the selection module SEL can select the control action to be executed and transmit it to the machine M to control the machine.

The trained machine learning module NN together with the selection module SEL can be regarded as an action selection rule or policy POL. As part of such a policy POL, the trained machine learning module NN predicts a particular accumulated performance for a respective operating state and multiple alternative control actions that can be applied, and the selection module SEL then uses the performance to select a control action to be applied.

FIG. 2 illustrates training of a learning-based simulator SIM of the machine M. The simulator SIM can be trained in a data-driven manner and is intended to model a state transition when a control action is applied to a predefined operating state of the machine M. Such a simulator is often also referred to as a transition model or dynamic system model.

The simulator SIM may be implemented in the machine controller CTL or wholly or in part externally thereto. In the present exemplary embodiment, the simulator SIM is implemented as an artificial neural network, in particular as a neural feedforward network.

The simulator SIM is intended to be trained on the basis of training data to take a respective operating state of the machine M and a respective control action as a basis for predicting a next state of the machine M that results from application of the control action to this operating state as accurately as possible.

The training of the simulator SIM is carried out on the basis of a large volume of first training data sets TD1, which, in the present exemplary embodiment, are stored in a database DB coupled to the machine controller CTL.

A respective first training data set TD1 in this case comprises a state data set S, an action data set A and a next-state data set S’. As already mentioned above, a respective state data set S specifies a respective operating state of the machine M and a respective action data set A specifies a respective control action that can be performed on the machine M. Accordingly, a respective next-state data set S’ specifies a respective next state that results from application of the respective control action to the respective operating state, that is to say an operating state of the machine M that is assumed in a subsequent time step. The data sets S, A and S’ contained in a respective first training data set TD1 are associated with one another there. Accordingly, the particular thus specified operating state has the associated particular specified control action and the associated particular specified next state.

The first training data sets TD1 are obtained while the machine M or a machine of the same design or a similar machine is in operation, for example by continuously measuring or otherwise acquiring operating states assumed during operation, control actions executed and resulting next states.

To train the simulator SIM, it is supplied with a plurality of pairs (S, A) comprising a respective state data set S and a particular associated action data set A as input data. The simulator SIM is intended to be trained such that the output data thereof reproduce a particular resulting next state as accurately as possible. The training is carried out by a supervised machine learning method.

Training in this case is generally understood to mean optimizing a mapping of input data, here the pairs (S, A) of a machine learning routine to the output data thereof. This mapping is optimized according to predefined and/or learnable criteria during a training phase. The criteria used can be, in particular, a prediction error in the case of prediction models and success of a control action in the case of control models. The training can be used for example to set or optimize network structures of neurons of a neural network and/or weights of connections between the neurons such that the predefined criteria are met as well as possible. The training can thus be regarded as an optimization problem. Many efficient optimization methods are available for such optimization problems in the field of machine learning, in particular gradient-based optimization methods, gradient-free optimization methods, backpropagation methods, particle swarm optimizations, genetic optimization methods and/or population-based optimization methods.

It is thus possible to train in particular artificial neural networks, recurrent neural networks, convolutional neural networks, perceptrons, Bayesian neural networks, autoencoders, variational autoencoders, Gaussian processes, deep learning architectures, support vector machines, data-driven regression models, k-nearest neighbor classifiers, physical models or decision trees. Accordingly, the simulator SIM and/or the machine learning module NN may also be implemented by one or more of the machine learning models cited above or can comprise one or more such machine learning models.

In the present exemplary embodiment - as already mentioned above - the simulator SIM is supplied with state data sets S and action data sets A comprising the training data as input data. For a respective pair (S, A) comprising a state data set S and an associated action data set A, the simulator SIM generates and outputs an output data set OS’ as a predicted next-state data set. The training of the simulator SIM tries to ensure that the output data sets OS’ correlate with the actual next-state data sets S’ as well as possible.

For this purpose, a divergence D between a respective output data set OS’ generated from a state data set S and an action data set A and the next-state data set S’ associated with this state data set S and action data set A is determined. The divergence D in this case can be regarded as a reproduction error or prediction error of the simulator SIM. The reproduction error D can be determined in particular by calculating a Euclidean distance between representative vectors of the data sets OS’ and S’ in question, e.g. according to D = |OS’ – S’| or D = (OS’ – S’)².

The determined reproduction errors D are - as indicated by a dashed arrow in FIG. 2 - returned to the simulator SIM. On the basis of the reproduction errors D that are returned, the simulator SIM is trained to minimize the reproduction errors D at least on statistical average. A plurality of efficient optimization methods are available for minimizing the reproduction errors D.

Minimizing the reproduction errors D trains the simulator SIM to predict a resulting next state for a predefined operating state and a predefined control action with sufficient accuracy.

FIG. 3 illustrates training of the machine learning module NN for predicting an accumulated performance of state trajectories. Each of such state trajectories comprises or specifies a succession of chronologically consecutive operating states of the machine M. A respective state trajectory can also comprise or specify control actions that were each executed between two consecutive operating states.

The accumulated performance of a state trajectory can be determined in particular by determining a state-specific performance value, e.g. a current power of the machine M, for the operating states contained therein, and by forming a weighted sum over the determined performance values. An accumulated performance is often also referred to as a return in the context of reinforcement learning. Where applicable, control actions specified by the state trajectory can also be evaluated in terms of their specific performance, e.g. in terms of their resource consumption, and included in the weighted sum. Typically, the performance values of a state trajectory are discounted into the future, i.e. the weighting factors of the weighted sum fall away towards the future.

To determine the accumulated performance of a given state trajectory, the machine controller CTL has a performance evaluator EV that derives the accumulated performance according to predefined performance criteria, e.g. from the given state trajectory as described above.

In this context, the training of the machine learning module NN serves the purpose of taking a given operating state and a given control action as a basis for predicting a performance of the machine M accumulated over multiple time steps into the future as realistically as possible. The problem here is that the state trajectory to be evaluated, which extends into the future, is not yet known, but only develops over time from the given operating state on the basis of the control actions performed. This problem is solved by using the trained simulator SIM to train the machine learning module NN in order to extrapolate into the future, or predict, operating states and control actions gradually. In this way, a state trajectory that stretches multiple time steps into the future is progressively constructed. A particular control action to be applied is determined by the machine learning module NN, which is in training. It turns out that the control actions determined in this way increasingly induce realistic state trajectories in the course of the training. An extrapolation of operating states into the future is often also referred to as roll-out or virtual roll-out.

For the constructed state trajectories, the performance evaluator EV can then be used to determine a particular accumulated performance value and to assign it to the respective pair comprising the operating state and the control action at the beginning of the state trajectory. The pairs comprising an operating state and a control action and the accumulated performance values are finally used for training the machine learning module NN. The training is explained in more detail below.

To train the machine learning module NN, the machine controller CTL reads a large volume of first training data sets TD1 from the database DB. Each of the training data sets TD1, as already mentioned above, comprises at least one state data set S and an action data set A. As already mentioned above, a respective state data set S contained in a first training data set TD1 specifies a respective operating state of the machine M and a respective action data set A contained in the same first training data set TD1 specifies a respective control action that can be performed on the machine M in this operating state.

The state data sets S and the action data sets A are fed into the control action generator SAG of the machine controller CTL. The control action generator SAG stores the action data sets A of the first training data sets TD1, in particular in order to assign them to other state data sets. Based on the stored action data sets A, the control action generator SAG determines, for each operating state specified by a state data set S, the control actions that can be applied as alternatives to one another in that operating state. As already described above, which particular control actions can be applied can be determined according to a predefined criterion.

By assigning additional alternative control actions to a respective state data set S, the control action generator SAG generates a plurality of further training data sets TDE that can better cover a space of potential control options. In this way, state trajectories that are not covered by the first training data sets TD1 can also be taken into account when predicting the accumulated performance or controlling the machine.

By analogy with FIG. 1, it will be assumed for the present exemplary embodiment that the control action generator SAG determines, for a considered state data set S, multiple control actions A1, …, AN that can be applied as alternative control actions in the operating state specified by this state data set S. As a result, the control action generator SAG generates multiple pairs (S, A1), …, (S, AN) containing the considered state data set S and a respective alternative control action of the alternative control actions A1, …, AN as further training data sets TDE. Each of these pairs (S, A1), …, (S, AN) is fed into the machine learning module NN to be trained as input data. In addition, the considered state data set S is transmitted to the trained simulator SIM and to the performance evaluator EV.

The machine learning module NN converts a respective fed-in pair (S, A1), … or (S, AN) into an output value OR1, … or ORN. The respective output value OR1, … or ORN is assigned to the particular corresponding control action A1, … or AN.

Each of the alternative control actions A1, …, AN is transmitted together with the corresponding output value OR1, … or ORN to the selection module SEL. The selection module SEL then selects the alternative control action of the alternative control actions A1, …, AN for which the corresponding output value OR1, … or ORN is at a maximum as the control action AS to be applied. This maximum output value will be referred to as ORS below. The control action AS to be applied is fed by the selection module SEL into the trained simulator SIM and into the performance evaluator EV.

The trained simulator SIM uses the transmitted state data set S and the control action AS that has been fed in to predict a next state that results from application of the control action AS to the operating state specified by the state data set S. The next state is represented by a next-state data set S’ that is fed by the trained simulator SIM into the performance evaluator EV and into the control action generator SAG.

In FIG. 3, the aforementioned predicted next-state data set S’ is referred to using the same reference sign as the next-state data set contained in the first training data sets TD1 in FIG. 2. Insofar as these next-state data sets are used in different training phases, confusion should be impossible.

The next-state data set S’ is processed by the control action generator SAG and also by the machine learning module NN, the selection module SEL and the trained simulator SIM in the same way as the state data set S that was fed in previously. That is to say that the control action generator SAG determines for the next-state data set S’ the control actions that can be applied as alternatives to one another in the next state in question, and forms pairs with the next-state data set S’ and a particular determined control action. These pairs are again fed into the machine learning module NN to be trained as input data. The input data are then processed further by the machine learning module NN, the selection module SEL and the trained simulator SIM in the same way as described above for the case of the state data set S.

In this way, the selection module SEL predicts a further control action AS’ to be applied and the trained simulator SIM predicts a further next state subsequent to the previously predicted next state. The further next state is represented by a next-state data set S’’ that is again fed into the performance evaluator EV and into the control action generator SAG. The above method is iterated with the next-state data set S’’ fed into the control action generator SAG and, where applicable, with further next-state data sets until a predefined termination criterion, e.g. a maximum number of iterations, is reached.

By virtue of consecutive next-state data sets S’, S’’, … being progressively fed into the performance evaluator EV starting from the state data set S, the performance evaluator can build a state trajectory ST = (S, S’, S’’, …) that starts from S. The state trajectory ST can also incorporate the control actions AS, AS’, AS’’, … that were each applied virtually between two consecutive operating states S, S’, S’’, …. Such a state trajectory can then be represented as ST = (S, AS, S’, AS’, S’’, AS’’, …).

The particular state trajectory ST built is rated in terms of its accumulated performance by the performance evaluator EV as described above. The performance evaluator EV determines an accumulated performance value R that quantifies the accumulated performance of the state trajectory ST. The determined accumulated performance value R is assigned to the pair (S, AS) comprising the state data set S and the selected control action AS from the beginning of the state trajectory ST. To some extent, the accumulated performance value R thus maps the future effects of applying the control action AS to the operating state specified by the state data set S.

As already mentioned above, the machine learning module NN is intended to be trained to predict the accumulated performance as accurately as possible. The training tries to ensure that the selected output values ORS of the machine learning module NN deviate from the accumulated performance values R as little as possible.

For this purpose, a divergence DR between a respective selected output value ORS and the corresponding accumulated performance value R is determined. The divergence DR in this case can be regarded as a prediction error of the machine learning module NN. The prediction error DR can be determined in particular by calculating a distance between the values in question, e.g. according to DR = |ORS – R| or DR = (ORS – R)².

The determined prediction errors DR are - as indicated by a dashed arrow in FIG. 3 - returned to the machine learning module NN. On the basis of the prediction errors DR that are returned, the machine learning module NN is trained to minimize the prediction errors DR at least on statistical average. A plurality of efficient optimization methods are available for minimizing the prediction errors DR. Minimizing the prediction errors DR trains the machine learning module NN to predict a performance accumulated into the future for a predefined pair comprising an operating state and a control action relatively accurately.

To speed up training, there can furthermore be provision for a control action AS that is to be applied currently not to be selected from the alternative control actions A1, …, AN that can be applied to the initial operating state S. Instead, the trained simulator SIM determines a particular next-state data set S1’, … or SN’ for all alternative control actions A1, …, AN. For each thus specified next state, all control actions to be subsequently applied are then selected again - as described above - by the selection module SEL. In this way, the performance evaluator EV builds a separate state trajectory ST for each of the initial alternative control actions A1, …, AN and determines a separate performance value R1, … or RN associated with the corresponding pair (S, A1), … or (S, AN). In this case, each of the prediction errors DR to be minimized is formed by the divergence of a respective performance value RJ from the corresponding output value ORJ, J=1, …, N, e.g. according to DR = |ORJ – RJ| or DR = (ORJ – RJ)².

In an embodiment, the performance evaluator EV can use the accumulated performance values R to derive a control quality. The control quality can be determined for example as a statistical mean value, in particular as a moving average of the accumulated performance values R. The control quality can serve as a benchmark for the quality of the machine controller CTL already attained. Training can then be continued until the control quality reaches a predefined quality value.

The trained machine learning module NN can then be used to control the machine M as described in connection with FIG. 1.

Although the present invention has been disclosed in the form of embodiments and variations thereon, it will be understood that numerous additional modifications and variations could be made thereto without departing from the scope of the invention.

For the sake of clarity, it is to be understood that the use of "a" or "an" throughout this application does not exclude a plurality, and "comprising" does not exclude other steps or elements.

1. A computer-implemented method for controlling a machine, comprising:
a) reading in a plurality of first training data sets in each of which an operating state of the machine has an associated control action;
b) generating further training data sets, using the operating states and control actions specified in the first training data sets, with new associations between operating states and control actions, so that a respective operating state is assigned multiple alternative control actions;
c) training a machine learning module with the first training data sets and the further training data sets to take an operating state and a control action as a basis for predicting a machine performance accumulated over a state trajectory of consecutive operating states as a resulting output value, with:
an operating state subsequent to a particular considered operating state in a state trajectory being determined by feeding, for each of the alternative control actions associated with the considered operating state, the considered operating state and the respective alternative control action into the machine learning module, taking the resulting output values of the machine learning module as a basis for selecting one of the alternative control actions, and using a simulator of the machine to determine an operating state that results from application of the selected control action to the considered operating state as the subsequent operating state,
a performance evaluator being used to determine a performance value accumulated over the operating states of a respective state trajectory, and
the machine learning module being trained to reproduce the determined accumulated performance values; and
d) controlling the machine by:
detecting a current operating state of the machine,
predicting an accumulated performance for each of the alternative control actions associated with the current operating state by the trained machine learning module,
actuating the machine using a control action that optimizes the predicted accumulated performance, and
if the optimizing control action is not executed successfully, selecting another of the alternative control actions on the basis of the accumulated performance thereof to control the machine.

2. The method as claimed in claim 1, wherein
alternative control actions associated with the current operating state are output together with a particular predicted accumulated performance via a user interface to select a control action to be executed.

3. The method as claimed in claim 1, wherein
a respective operating state specified in the first training data sets has, in addition to an associated control action, an associated next state that results from application of the control action to the operating state.

4. The method as claimed in claim 3, wherein
the simulator is trained by the first training data sets to take a respective operating state and a respective control action as a basis for reproducing the particular resulting next state.

5. The method as claimed in claim 3, wherein
the operating states, control actions and/or next states specified in the first training data sets are detected while the machine or a machine of the same design or a similar machine is in operation.

6. The method as claimed in claim 1, wherein control actions that can be applied in a respective operating state are determined, and
in that the respective operating state is assigned all control actions that can be applied as alternative control actions.

7. The method as claimed in claim 1, wherein the determination of a subsequent operating state in the state trajectory results in the alternative control action that optimizes the resulting output value of the machine learning module being selected.

8. The method as claimed in claim 1, wherein if a first control action is not executed successfully, the other alternative control action for which the next best accumulated performance compared to the first control action was predicted is selected to control the machine.

9. The method as claimed in claim 1, wherein
an action selection rule for selecting a control action to be applied in a current operating state is implemented in such a way:
that an accumulated performance is predicted by the trained machine learning module for the current operating state and each of one or more control actions that can be applied, and
that the control action of the one or more control actions that can be applied for which the best accumulated performance was predicted is selected as the control action to be applied.

10. The method as claimed in claim 1, wherein a control quality is derived from the accumulated performance values during the training of the machine learning module, and
in that the training is continued until a predefined control quality is attained.

11. A machine controller, configured to carry out all method steps of a method as claimed in claim 1.

12. A computer program product, comprising a computer readable hardware storage device having computer readable program code stored therein, said program code executable by a processor of a computer system to implement a method as claimed in claim 11 to carry out a method.

13. A computer-readable storage medium containing a computer program product as claimed in claim 12.
